(19) United States
(12) Patent Application Publication
(10) Pub. No.: US 2016/0279659 A1
(43) Pub. Date: Sep. 29, 2016

(54) APPARATUS AND METHOD FOR TREATING SHEET-LIKE MATERIAL

(71) Applicants: Hans-Kurt SCHROMM, Backnang (DE); Matthias KLEINHANS, Waiblingen (DE); Manfred GOTTLOEBER, Villingen (DE)

(72) Inventors: Hans-Kurt SCHROMM, Backnang (DE); Matthias KLEINHANS, Waiblingen (DE); Manfred GOTTLOEBER, Villingen (DE)

(21) Appl. No.: 15/036,305

(22) PCT Filed: Oct. 22, 2014
(86) PCT No.: PCT/EP2014/072595

§ 371 Date: May 12, 2016

(30) Foreign Application Priority Data
Nov. 13, 2013 (DE) 10 2013 223 151.2

(51) Int. Cl. B05C 1/00; F26B 21/00; F26B 13/10

(52) U.S. Cl. CPC B05C 1/00; F26B 13/10; F26B 21/004

(57) ABSTRACT

An apparatus for treating sheet-like material, in particular panels, film or foil, the apparatus having at least one bar-shaped or rod-shaped strip which is disposed so as to be transverse to the longitudinal direction of the sheet-like material, the sheet-like material being moved past the strip in the longitudinal direction, wherein the strip, at least across part of the external face thereof that faces the sheet-like material, is composed of a porous fluid-permeable metal foam, and wherein an arrangement for conveying a treatment fluid through the metal foam toward the sheet-like material is provided.

The invention relates to an apparatus for treating sheet-like material, in particular panels, film or foil, the apparatus having at least one bar-shaped or rod-shaped strip which is disposed so as to be transverse to the longitudinal direction of the sheet-like material, the sheet-like material being moved past the strip in the longitudinal direction. The invention also relates to a method for treating sheet-like material, using an apparatus according to the invention.

The intention of the invention is to provide an improved apparatus and an improved method for treating sheet-like material.

To this end, according to the invention, an apparatus for treating sheet-like material, in particular panels, film or foil, is provided, the apparatus having at least one bar-shaped or rod-shaped strip which is disposed so as to be transverse to the longitudinal direction of the sheet-like material, the sheet-like material being moved past the strip in the longitudinal direction, wherein the strip, at least across part of the external face thereof that faces the sheet-like material, is composed of a porous fluid-permeable metal foam, and wherein means for conveying a treatment fluid through the metal foam toward the sheet-like material are provided.

An at least portion-wise configuration of the strip of porous fluid-permeable metal foam allows a liquid or gaseous treatment fluid to be directed through the metal foam in an extremely uniform manner toward the sheet-like material. The disadvantage of individual nozzles which, in spatial terms, typically always have non-uniform flow distribution can be especially avoided. By contrast, constant flow conditions may be achieved by using an open-cell metal foam across the entire face of the strip. This is extremely advantageous specifically in the case of very sensitive sheet-like material, for example in the case of coated panels, film or foil.

In one refinement of the invention, the strip is configured as a tube, the tube, across at least part of the external circumference thereof, being composed of the metal foam.

In the case of a tube being provided, the treatment fluid may be infed in the interior of the tube and then be discharged in a radially outward manner through the tube.

In one refinement of the invention, the tube is composed entirely of metal foam.

In one refinement of the invention, part of the external circumference of the tube is configured so as to be gas-impermeable.

A flow of the treatment fluid may be discharged in a directed manner in this way. The metal foam may be rendered gas-impermeable by re-grinding, re-turning, or else by coating, for example with a plastics material.

In one refinement of the invention, the metal foam is a stainless-steel metal foam, in particular of chromium nickel stainless steel.

A long service life may be achieved in this way, on the one hand, and the apparatus according to the invention is also employable in corrosive environments.

In one refinement of the invention, the metal foam has between 45% and 80% nickel, and between 15% and 45% chromium.

In one refinement of the invention, the metal foam has carbon, copper, iron, molybdenum, manganese, phosphorus, and/or zinc, in each case in a proportion of less than 1%.

In one refinement of the invention, the metal foam has a porosity of 90% or more.

The porosity relates to the cavities in the foamed metal. A porosity of 90% means that 90% of the entire volume is composed of air or of cavities, and only 10% is composed of solid material.

In one refinement of the invention, the metal foam has a mean pore size in the range between 0.3 mm and 2.5 mm. Metal foam more or less has a statistical distribution of the pore size such that only a mean pore size can be stated.

In one refinement of the invention, the apparatus is configured as a lock.

The apparatuses according to the invention may in particular be advantageously employed as locks which operate in a non-contacting manner where a treatment space is to be separated from the environment and where the sheet-like material to be treated, when passing the lock, is still extremely sensitive. A lock according to the invention may achieve extremely uniform distribution of flow such that a sheet-like material to be treated is not or is only insignificantly compromised by the lock gas.

In one refinement of the invention, a treatment space is provided, the at least one strip being disposed in the treatment space.

The apparatus according to the invention is particularly suitable for post-treating sheet-like materials, for example by means of liquid or gaseous treatment fluids. A very uniform flow of the treatment fluid toward the sheet-like material to be treated may be achieved on account of the metal foam which is used according to the invention, resulting in a very uniform surface texture of the treated sheet-like material.

In one refinement of the invention, the means for conveying a treatment fluid are configured for conveying cold or hot gas.

In one refinement of the invention, the strip is configured as a tube and is composed of metal foam across at least 180° of the external circumference thereof.

By way of these measures the rod may be used for the treatment of web-shaped material which is guided in an arcuate manner along the external circumference thereof.

In one refinement of the invention, the sheet-like material is configured so as to be web-shaped, and is deflected along the external circumference of the strip, and changes direction.

In one refinement of the invention, a plurality of strips are disposed so as to be spaced apart, the sheet-like material being guided through between the strips.

The invention also relates to a method for treating sheet-like material, in particular panels, film or foil, using an apparatus according to the invention, in which method it is provided that a sheet-like material to be treated is moved past at least one bar-shaped or rod-shaped strip which is disposed so as to be transverse to the longitudinal direction of the sheet-like material, the strip, at least across part of the external face thereof that faces the web-shaped material, being composed of a porous gas-permeable metal foam, and in which a treatment fluid is conveyed through the metal foam toward the sheet-like material.

Further features and advantages of the invention are derived from the claims and from the following description of preferred embodiments of the invention in conjunction with the drawings. Here, individual features of the various embodiments as illustrated in the individual figures may be combined with one another in an arbitrary manner without departing from the context of the invention. In the drawings:

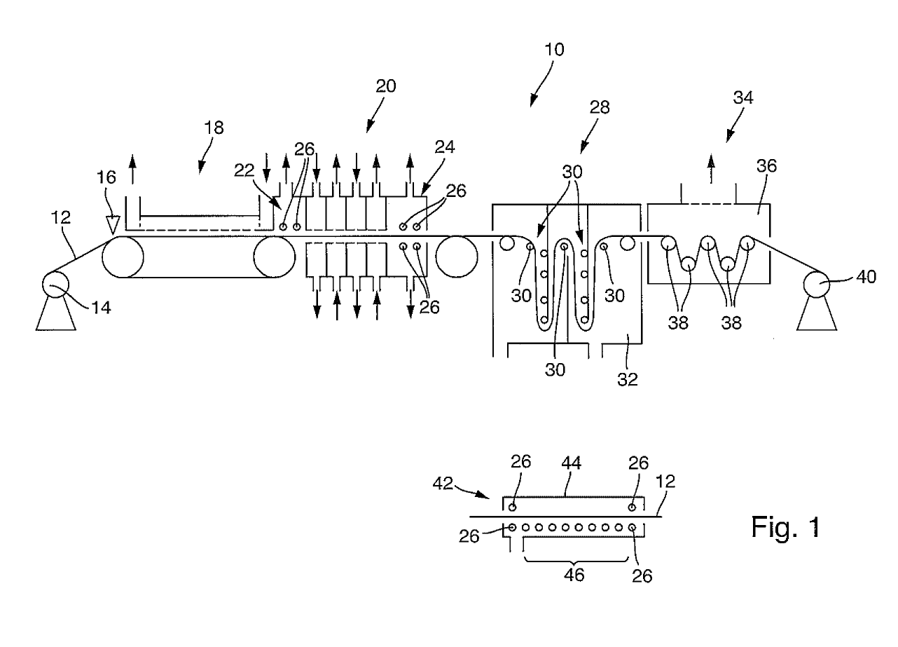

FIG. 1 shows a schematic illustration of an apparatus according to the invention for treating sheet-like material, according to a first embodiment;

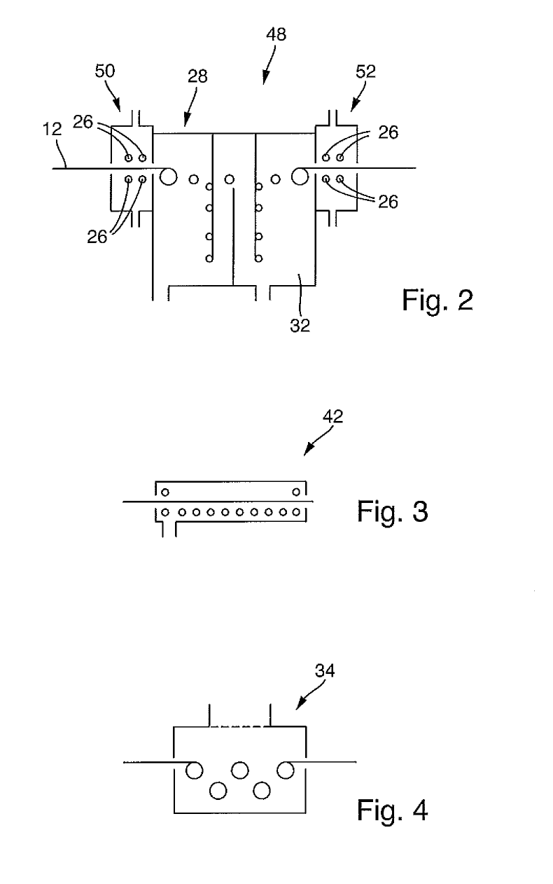

FIG. 2 shows a schematic illustration of an apparatus according to the invention, according to a second embodiment;

FIG. 3 shows a schematic illustration of a portion of the apparatus of FIG. 1;

FIG. 4 shows a schematic illustration of a further portion of the apparatus of FIG. 1;

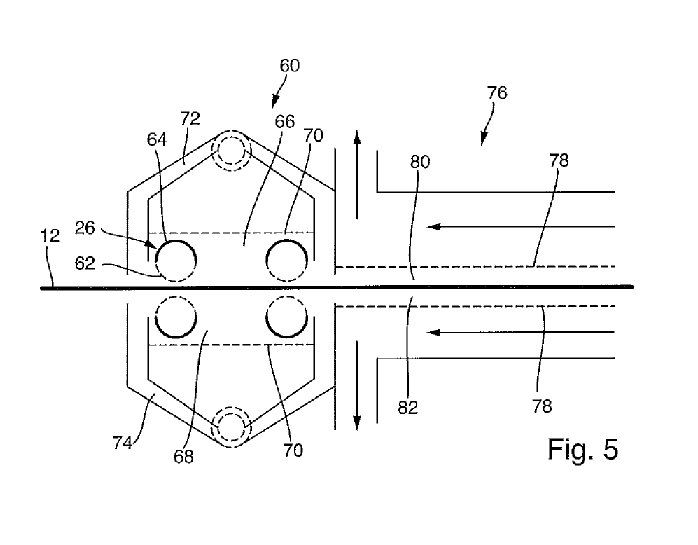

FIG. 5 shows a schematic illustration of an apparatus according to the invention that is configured as a lock;

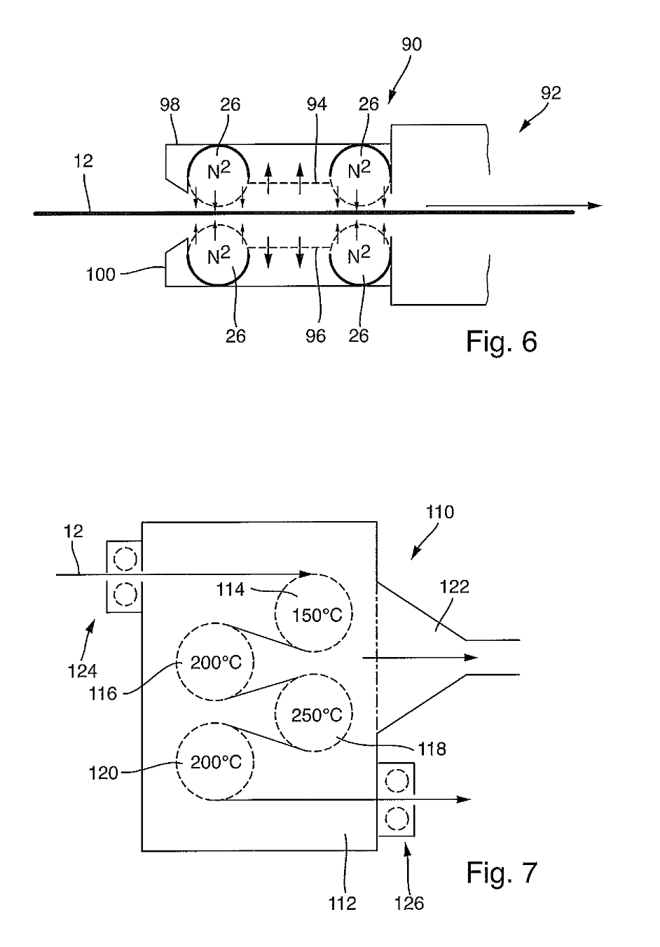

FIG. 6 shows a schematic illustration of a further apparatus according to the invention that is configured as a lock;

FIG. 7 shows a schematic illustration of a further apparatus according to the invention; and

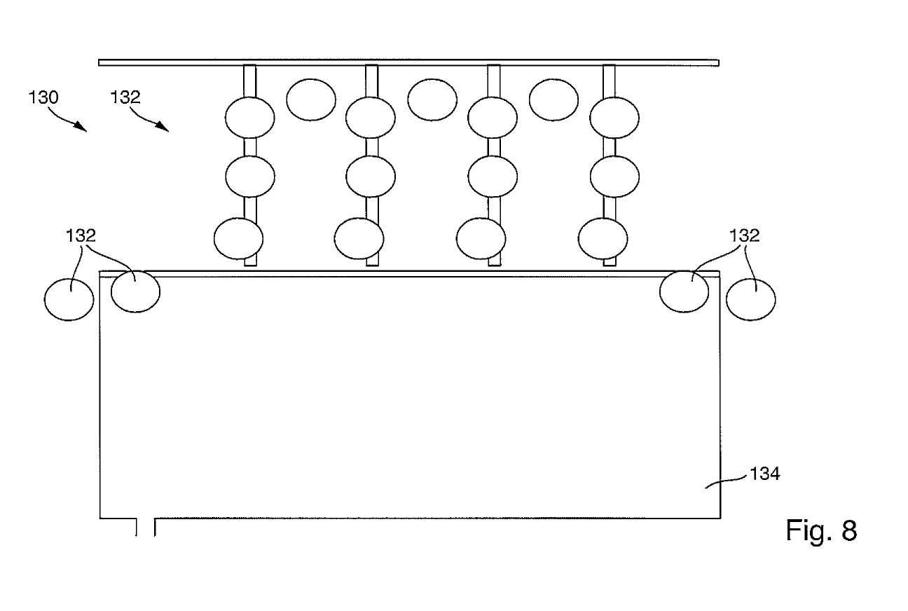

FIG. 8 shows a schematic illustration of a further apparatus according to the invention.

The illustration of FIG. 1 schematically shows an apparatus 10 according to the invention for treating sheet-like material, a web-shaped foil 12 being treated or coated, respectively, dried, and thereafter post-treated by the illustrated apparatus 10. The foil 12 is wound up on a storage drum 14 and is infed to a coating apparatus 16. A material which is initially liquid is applied onto the foil 12 by the coating apparatus 16, said material then forming a liquid film on the upper side of the foil 12. The application apparatus is immediately followed by a first drier 18 and subsequently by a floating air drier 20. The foil 12 is dried from both sides in the floating air drier 20. Locks 22 or 24, respectively, according to the invention are disposed upstream and downstream of the floating air drier 20. The locks 22 and 24 each have two tubes 26 which are composed of metal foam, lock gas being conveyed therethrough toward the foil 12. The tubes 26 are each disposed in a lock space from which the lock gas thereafter is suctioned off. The lock 24 has four tubes of metal foam 26, two of the tubes 26 being disposed above the foil 12, and two of the tubes 26 being disposed below the foil 12. In each case one lock space from which the lock gas thereafter is suctioned off is disposed above and below the foil 12.

A post-treatment apparatus 28 in which the foil 12 is post-treated by means of a treatment liquid is provided downstream of the floating air drier 20. The apparatus 28 has a plurality of tubes 30, each being composed of a gas-permeable metal foam and a treatment liquid being conveyed therethrough toward the foil 12. The tubes 30 are disposed within a tank 32 in which the treatment liquid is likewise located.

A hot-gas treatment apparatus 34 according to the invention is provided downstream of the apparatus 28. The apparatus 34 has tubes 38 which are disposed within a treatment space 36, the foil 12 being deflected about each of said tubes 38 which are composed of gas-permeable metal foam. Hot gas is conveyed through the tubes 38 toward the foil 12. On account thereof, the foil 12 is held so as to be spaced apart from the tubes 38, even if this cannot be seen in the illustration of FIG. 1. As can be seen, the foil 12 is deflected about the tubes 38 such that both the lower side as well as the upper side of the foil 12 are treated by means of hot gas which is conveyed in a very uniform manner across at least part of the external circumference of the tubes 38 toward the foil 12. The gas makes its way into the treatment space 36 from which it is thereafter suctioned off.

Upon leaving the treatment space 36, the foil 12 is wound onto a storage drum 40.

An apparatus according to the invention that may be employed as an alternative to the apparatus 28 is referenced with the numeral 42. The apparatus 42 is provided for treatment using both gaseous as well as liquid treatment fluid. The apparatus 42 at the entry thereof has two lock tubes 26 which convey lock gas toward the foil 12, preventing ambient air from entering a treatment space 44 of the apparatus. In the same way, two lock tubes 26 of metal foam are disposed at the exit of the treatment space 44, lock gas being likewise conveyed therethrough toward the foil 12 and said two lock tubes 26 likewise preventing ambient air from entering the treatment space 44. A plurality of tubes 46 of metal foam through which treatment gas is conveyed toward the lower side of the film 12 are disposed below the foil 12 within the treatment space.

The illustration of FIG. 2 schematically shows an apparatus 48 according to the invention which contains the apparatus 28 of FIG. 1, which has already been discussed. Locks 50 and 52, respectively, through which the foil 12 is guided into the treatment tank 32 and out of the latter again, respectively, are provided upstream and downstream of the treatment tank 32 of the apparatus 28. The locks 50, 52 each have two tubes 26 composed of metal foam disposed above the foil 12, and two tubes 26 composed of metal foam disposed below the foil 12, lock gas being conveyed therethrough toward the upper side and the lower side of the foil 12, respectively. The tubes 26 are each disposed within one lock space from which the lock gas is thereafter suctioned off. The locks 50, 52 prevent ambient air from entering the treatment tank 32.

The illustration of FIG. 3 again shows the apparatus 42 of FIG. 1, thereby allowing a repetition of the discussion of the apparatus 42 to be dispensed with.

The illustration of FIG. 4 schematically shows the portion 34 of the apparatus 10 of FIG. 1. Here too, re-discussing the construction and the function of the apparatus 34 is dispensed with.

The illustration of FIG. 5 schematically shows an apparatus 60 according to the invention which is configured as a lock. In each case two tubes 26 of metal foam are disposed above and below the foil 12. As can be derived from the illustration of FIG. 5, it is only the lower half 62 of the external circumference of the tube 26 that is configured so as to be gas-permeable. The pores of the metal foam of the tubes are closed in the upper half 64 of the external circumference. This may be performed for example by re-grinding or else by coating the metal foam. On account thereof, gas from the interior of the tube 26 exits only across an angular range of 180° of the external circumference, specifically toward the foil 12. A very uniform flow of the lock gas toward the foil 12 is achieved by the numerous open pores of the metal foam in the portion 62. The tubes 26 are disposed in an upper lock space 66 and in a lower lock space 68, respectively, each being delimited by the foil 12, on the one hand, and by one porous gas-permeable metal plate 70, on the other hand. The metal plates 70 may likewise be composed of metal foam. The lock spaces 66, 68 are laterally delimited by the side walls of a double hood 72 or 74, respectively, the latter extending so as to stop short of the upper side or the lower side of the foil 12, respectively. A further flow space through which lock gas may likewise be suctioned off is created in the cavity between the walls of the double hoods 72, 74. Lock gas flows through the respective portions 62 of the tubes 26 toward the foil 12, is then laterally deflected, and is extracted by way of the gas-permeable plates 70, on the one hand, and through the flow spaces in the hoods 72, 74, on the other hand.

Such a construction of the lock 60 allows reliable sealing in relation to the entry of ambient air into a subsequent treatment space of a drier 76. The foil 12 is nevertheless not contacted in the lock and is also not impinged by severe and above all by non-uniform flows of lock gas, since a very uniform flow of lock gas toward the foil 12 may be achieved by way of the numerous open pores of the portions 62 of the tubes 26.

The drier 76 is configured as a floating air drier and above and below the foil 12 has in each case one porous gas-permeable metal plate 78 composed of metal foam. A flow space through which gas flows parallel with the metal plates 78 is in each case disposed above and below the metal plates 78, respectively. On account thereof, gas is suctioned and conveyed away by the venturi effect from a respective drying space 80 above the foil, or from a drying space 82 below the foil 12, respectively.

The illustration of FIG. 6 schematically shows a further apparatus 90 according to the invention, which is configured as a lock and is disposed upstream of a drier 92 which is not further discussed.

The lock 90 also has four tubes 26 composed of metal foam, in each case only an angular range of 180° that faces the foil 12 being configured so as to be gas-permeable. To this extent, the tubes 26 are configured so as to be identical to the tubes 26 which have been discussed by means of FIG. 5. Nitrogen as a lock gas is conveyed through the tubes 26 toward the foil 12. A metal-foam plate 94 is disposed between the two tubes 26 which are disposed above the foil 12, a metal-foam plate 96 being likewise disposed between the tubes 26 which are disposed below the foil 12. The metal-foam plates 94, 96 are gas-permeable. Gas is suctioned off above the metal-foam plate 94 and below the metal-foam plate 96, respectively.

As compared with the lock 60 of FIG. 5, the lock 90 of FIG. 6 is of a simpler construction, since the double hoods 72, 74 have each been replaced by a hood 98, 100 of single-wall configuration.

The illustration of FIG. 7 schematically shows an apparatus 110 according to the invention, which is configured as a hot-gas treatment apparatus. The apparatus 110 has a treatment space 112 in which a total of four tubes 114, 116, 118, and 120 are disposed, each tube being composed of metal foam. The tubes 114, 116, 118, and 120 are each configured so as to be gas-permeable either across the entire external circumference thereof, or else only across the contact arc to the foil 12 to be treated. The foil 12 to be treated is guided in a meandering manner about the tubes 114, 116, 118, and 120, and is deflected by somewhat more than 180° at each tube 114, 116, 118, and 120. The deflection of the foil 12 here is performed in a non-contacting manner since hot gas is in each case conveyed in a radially outward manner from the interior of the tubes 114, 116, 118, 120 toward the foil 12. Here, hot gas at a temperature of 150° C. is conveyed through the tube 114 toward the foil 12, hot gas at a temperature of 200° C. is conveyed through the tube 116, hot gas at temperature of 250° C. is conveyed through the tube 118, and hot gas at a temperature of 200° C. is conveyed through the tube 120. On account thereof, the foil 12 may be subjected to treatment at graduated temperatures, the foil 12 here, as has been discussed, being guided by the flows of hot gas out of the tubes 114, 116, 118, and 120 in a non-contacting manner through the treatment space 112. Gas is suctioned off from the treatment space 112 via an exit opening 122. One lock 124 and 126, respectively, is each disposed at the entry of the foil 12 into the treatment space 112, and at the exit of the foil 12 from the treatment space 112. The construction of the locks 124, 126 is comparable to that of the locks 60, 90, according to FIGS. 5 and 6, which have already been discussed, and will not be re-described.

The illustration of FIG. 8 shows a further apparatus 130 according to the invention according to the invention, which is provided for treating the web-shaped material (not illustrated) with a treatment liquid. The apparatus 130 has numerous tubes 132, the treatment liquid being conveyed in each case in a radially outward manner therethrough. The tubes 132 are each composed of an open-cell metal foam such that the treatment liquid is discharged very uniformly in a radially outward manner across the external circumference of the tubes 132. A web-shaped material to be treated, which is not illustrated in FIG. 8, is threaded in a suitable manner between the tubes 132; the tubes 132 are then disposed within a treatment tank 134. Treatment fluid then flows in a radially outward manner through the walls of the tubes 132, the web-shaped material to be treated, on account thereof, being guided in a non-contacting and meandering manner through the treatment tank 134. On account thereof, the web-shaped material may be conveyed in a continuous manner through the treatment tank 134, being uniformly impinged from both sides by the treatment liquid. Here, the porosity and the pore size of the tubes 132 which are composed of metal foam are specified to the viscosity and/or to the particle size of the treatment liquid, in order for the desired flow conditions to be achieved.

1. An apparatus for treating sheet-like material, in particular panels, film or foil, the apparatus having at least one bar-shaped or rod-shaped strip which is disposed so as to be transverse to the longitudinal direction of the sheet-like material, the sheet-like material being moved past the strip in the longitudinal direction, wherein the strip, at least across part of the external face thereof that faces the sheet-like material, is composed of a porous fluid-permeable metal foam, and the apparatus additionally includes means for conveying a treatment fluid through the metal foam toward the sheet-like material.

2. The apparatus as claimed in claim 1, wherein the strip is configured as a tube, the tube, across at least part of the external circumference thereof, being composed of the metal foam.

3. The apparatus as claimed in claim 2, wherein the tube is composed entirely of metal foam.

4. The apparatus as claimed in claim 2, wherein part of the external circumference of the tube is configured so as to be gas-impermeable.

5. The apparatus as claimed in claim 1, wherein the metal foam is a stainless-steel metal foam, in particular of chromium nickel stainless steel.

6. The apparatus as claimed in claim 5, wherein the metal foam has between 45 percent and 80 percent nickel, and between 15 percent and 45 percent chromium.

7. The apparatus as claimed in claim 6, wherein the metal foam has carbon, copper, iron, molybdenum, manganese, phosphorus, and/or zinc, in each case in a proportion of less than 1 percent.

8. The apparatus as claimed in claim 1, wherein the metal foam has a porosity of 90 percent or more.

9. The apparatus as claimed in claim 1, wherein the metal foam has a mean pore size in the range between 0.3 mm and 2.5 mm.

10. The apparatus as claimed in claim 1, wherein the apparatus is configured as a lock.

11. The apparatus as claimed in claim 1, wherein a treatment space is provided, the at least one strip being disposed in the treatment space.

12. The apparatus as claimed in claim 11, wherein the means for conveying a treatment fluid is configured for conveying cold gas or hot gas.

13. The apparatus as claimed in claim 1, wherein the strip is configured as a tube and is composed of metal foam across at least 180 angular degrees of the external circumference thereof.

14. The apparatus as claimed in claim 1, wherein the sheet-like material is configured so as to be web-shaped, and is deflected along the external circumference of the strip, and changes direction.

15. The apparatus as claimed in claim 1, wherein a plurality of strips are disposed so as to be spaced apart, the sheet-like material being guided through between the strips.

16. A method for treating sheet-like material, in particular panels, film or foil, using an apparatus as claimed in claim 1, the method including moving a sheet-like material to be treated past at least one bar-shaped or rod-shaped strip which is disposed so as to be transverse to the longitudinal direction of the sheet-like material, the strip, at least across part of the external circumference thereof that faces the web-shaped material, being composed of a porous gas-permeable metal foam, and conveying a treatment fluid through the metal foam toward the sheet-like material.
